(19) United States
(12) Patent Application Publication
(10) Pub. No.: US 2010/0012230 A1
(43) Pub. Date: Jan. 21, 2010

(54) APPARATUS AND METHOD FOR THE HEAT TREATMENT OF INTEGRAL ROTORS OF GAS TURBINES

(75) Inventors: Hermann BAUR, Sielenbach (DE); Hans Pappert, Kufstein (AT); Bernd Stimper, Dachau (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/354,412

(22) Filed: Jan. 15, 2009

(30) Foreign Application Priority Data
Jan. 19, 2008 (DE) 10 2008 005 234.5

(51) Int. Cl. C21D 1/09; H05B 6/10; H05B 7/00; B23K 26/00; C21D 1/10; C22F 1/00

(52) U.S. Cl. 148/525; 219/635; 219/121.12; 219/121.6; 266/99; 148/526; 148/527

(57) ABSTRACT

An apparatus for the heat treatment of integral rotors of gas turbines is disclosed. The apparatus includes a closable working space which can be evacuated or filled with inert gas, a heat source, a distance-measuring instrument, and a pyrometer. A method for diminishing and/or for eliminating internal stresses which are introduced into a component through welding is also disclosed.

This application claims the priority of German Patent Document No. 10 2008 005 234.5, filed Jan. 19, 2008, the disclosure of which is expressly incorporated by reference herein.

### BACKGROUND AND SUMMARY OF THE INVENTION

The invention relates to an apparatus as well as a method for the heat treatment of integral rotors of gas turbines.

A known possibility of bringing components into a state which, as far as possible, is distinctly stress-free consists in placing these components in a furnace and reducing the introduced stresses through appropriate temperature control. However in the case of integral rotors or blades of gas turbines, in particular turbines or compressor blades, the above-mentioned possibility frequently leads to rather inadequate results, as the properties which are introduced through pre-working during production of the component are changed in the entire component, i.e., also in areas which were not affected by the welding process. In various cases this would result in the general loss of intended material properties or of component states and is therefore frequently undesirable.

This is compounded by the fact that components of engines are frequently subject to component individuality following use of the engine, i.e., component changes are greatly dependent on the use, such as the field of use, length of the flights, etc., of the aircraft. Therefore predefined processes can hardly be applied. It is rather desirable to take account of the component individuality, i.e., for example, the differences in shape and position as well as the individual degree of aging of the components, when defining the heat treatment.

Against this background, integral rotors of turbines or aircraft engines were previously not repaired. This means that in the case of turbines, in particular in the case of aircraft engines, the costs which were entailed by damaged integral turbines are at present relatively high.

Against this background, the object of the invention is to create a possibility by means of which the costs for repairing gas turbines, in particular aircraft engines, in the case of damaged integral rotors can be kept to a minimum.

Therefore an apparatus for the heat treatment of integral rotors of gas turbines, such as, for example, of aircraft engines, which comprises a closable working space is in particular provided. A vacuum can in particular be produced in the working space. The working space can additionally or alternatively be fillable with inert gas. For this purpose the apparatus can comprise an appropriate evacuation device or vacuum device or an inert-gas filling device. The apparatus also comprises a heat source. This heat source is an inductor or a high-frequency source or an electric arc or a laser or an electron beam or an apparatus which produces an electric arc or an electron beam. Other heat sources are also preferred. The apparatus also comprises a distance-measuring instrument. The distance-measuring instrument serves in particular to detect the distance between the heat source, in particular the inductor, and the component or component portion that is to be heat-treated, such as, for example, a blade, in particular a blade of an integral rotor. The distance-measuring instrument is advantageously connected for signalling purposes to a position-changing device for changing the position of the heat source and/or of the component to be heat-treated. A control unit is optionally interconnected. This signal connection can in particular serve—in particular by means of the position changing unit—to keep the distance between the component to be heat-treated or the component portion which is to be heat-treated and the heat source or inductor to a predetermined, in particular constant, distance.

This is in particular such that the distance relating to the location which is to be heat-treated at the time is targeted, i.e., the distance between the above-mentioned location and the heat source.

The apparatus according to the invention also comprises a pyrometer.

The pyrometer is in particular such that it establishes the temperature at the location which is to be heat-treated or is instrumental in establishing the temperature at this location. The pyrometer can be connected for signalling purposes to a control unit and/or to the heat source. The pyrometer or the control unit can in this respect regulate the on-period and/or intensity of the heat source in accordance with the values detected by the pyrometer. It is possible, for example, for—in particular in the case of the inductor—signals to be produced by means of the pyrometer or a control unit, in accordance with the values detected by the pyrometer, which regulate the on-period of the fixed frequency with which the interaction time between the magnetic field and the component is controlled according to a set desired temperature as the control circuit.

It can be made possible by means of the method according to the invention or its developments to reduce internal stresses introduced into a component during a welding operation and therefore restore a state of stress which approaches that of new parts or largely corresponds to that of new parts. It is therefore more possible to attain the result, or even to ensure, that components which are treated in this way do not behave differently, or only to a slight degree, under vibrating excitation when the engine is running, as compared to components on which no repairs have been carried out.

### BRIEF DESCRIPTION OF THE DRAWING

An embodiment of the invention shall now be illustrated in detail in the following on the basis of the figure, in which:

FIG. 1 shows an exemplary apparatus according to the invention in a schematic view.

### DETAILED DESCRIPTION OF THE DRAWING

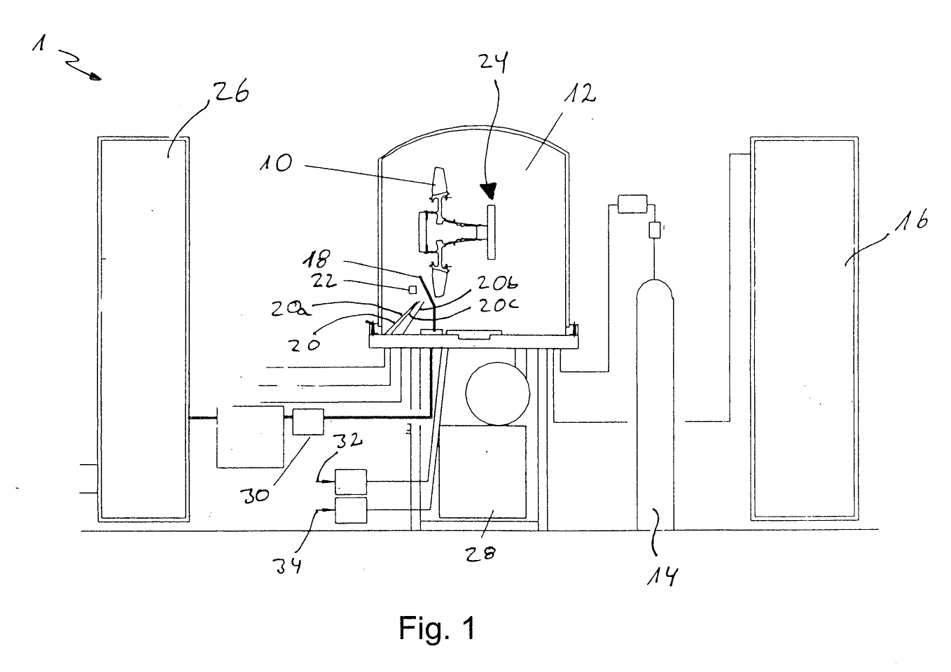

FIG. 1 shows an exemplary apparatus 1 according to the invention for the heat treatment of integral rotors 10 of gas turbines, namely in particular for the heat treatment of integral rotors of aircraft engines.

An integral rotor can, for example, be formed as a so-called BLISK (“bladed disk”) or as a so-called BLING (“bladed ring”). In the embodiment the integral rotor 10 is a BLISK. However it is to be noted that a differently formed component or a differently formed integral rotor 10 can be used. BLISK or blade is referred to in the following by way of example, while it is to be noted that the component can also be a differently formed component or workpiece.

The plant or the apparatus 1 comprises a closed or closable working space 12, which can also be called a chamber. The working space 12 can also be called a vacuum chamber, provided that it can be evacuated.

The working space 12 can be or is evacuated and/or can be or is flooded with inert gas. An argon cylinder manifold 14 is provided in FIG. 1, this being connected to the working space 12 and enabling flooding with inert gas or argon to take place. It is to be noted that a different inert gas can of course be used. A vacuum plant 28 is provided to produce a vacuum in the working space 12.

The evacuation or flooding with inert gas can be CNC-controlled, for example. The apparatus comprises a control device 16 which can control the method which can be carried out in the plant or controls the plant.

In the method which can be carried out in the apparatus 1 or the method according to the invention a negative pressure such as, for example, a negative pressure of 1 mbar can be produced in the working space 12, namely preferably upon simultaneous flooding with argon. In this respect the working space 12 can be evacuated beforehand, such as, for example, evacuated to 0.001 mbar. Furthermore, the negative pressure can subsequently be maintained constant, such as, for example, maintained constant at 0.01 mbar, which is regulated, for example, via the inert gas or argon supply. It is to be noted in this connection that argon is always mentioned in this embodiment, while a different inert gas can of course also be used. The partial high pressure of the vacuum or the inert gas flow can be monitored and regulated following evacuation or flooding. It is in addition possible to measure the residual oxygen content, for example online, and represent it on an indicator device or on a general chart, namely in particular with the actual values.

It is to be noted that an ideal vacuum is called the vacuum, or a state with a small amount of residual gas, such as residual gas at a pressure or partial pressure of less than 0.008 mbar, preferably of less than 0.005 mbar, preferably of less than 0.003 mbar, preferably of less than 0.002 mbar, preferably of 0.001 mbar or less.

The apparatus 1 also comprises a heat source 18. In the configuration according to FIG. 1 this heat source 18 is formed as an inductor or as an induction coil. The heat source or the induction coil 18 is mobile—in particular with the fastening—and can in particular be pivoted in one direction, such as, for example, through 10° in each case. A manual adjustment facility, for example, can also be provided, this serving to readjust the coil 18 in relation to the blade. However an adjustment facility of this kind can also be automated or have automation backup. The blade position can also be adjustable. In the case of the configuration with a pivotable induction coil the 0° position can be monitored with a switch via the CNC control. It is then possible to ensure that, following a coil change, the CNC control automatically detects whether the coil is again located in the 0° position.

As is quite evident from FIG. 1, the induction coil 18 is disposed inside the working space 12. In the configuration according to FIG. 1 the connections of the induction coil 18 are likewise disposed inside the working space 12. These connections can be designed as quick-acting connections. It is possible to use an adapter piece for the coil that is present. A cooling water flow with current passage can be controlled in the connection of the induction coil 18 or in the quick-acting connection of the induction coil 18. The apparatus 1 also comprises at least one pyrometer 20. Three pyrometers are provided in FIG. 1, these being given the reference numbers 20a, 20b and 20c to distinguish between them better. Thermocouples, which are not represented in detail, can also be provided, as well as a laser measuring system, which can in particular be used as a distance-measuring instrument 22. The distance-measuring instrument 22 serves in particular to establish the distance between the heat source or the inductor and the location of the integral rotor 10 which is to be heat-treated with this heat source 18.

Thermocouples, which are not shown in detail, can also be provided.

The pyrometer connections, the connections for the thermocouples as well as the laser measuring system can likewise be integrated in the quick-acting connection.

As already indicated, the position of the induction coil or the heat source in relation to the BLISK blade or in relation to the location to be heat-treated can be integrated via a laser measuring system 22 which is integrated into the coil, while there is of course also the possibility of using distance-measuring instruments other than the laser measuring systems. The signal generated by the distance-measuring instrument 22 or laser measuring system 22 can be received and taken into account by the CNC control.

A measuring system with which differences in shape and position of the components or components or BLISKs or integral rotors which are to be heat-treated prior to and between the working process can be detected can also be present in the working space 12. This can be effected through the laser measuring system 22 integrated into the coil. The measured values can be taken into account in an adaptive and automatic manner, for example, in the positioning of the component or integral rotor or BLISK in relation to the induction coil. This can take place, for example, via the CNC control.

A video camera for monitoring the process can also be provided inside the working space 12 and can optionally be zoomed up to the working location by a zoom function. This can serve the purpose of optically monitoring the process with an evacuated or a flooded working space. The heat treatment operation can be regulated, for example, with two pyrometers 20 integrated in the induction coil and a “rod furnace control” with ECS2000 interface for data output or recording. The heat treatment sequence can be integrated into the CNC control. The control system can in this respect comprise the CNC control. It is to be noted that—as far as CNC control is mentioned here—another electronic or non-electronic control can of course also be present. The above-mentioned thermocouples are provided for additional temperature monitoring. Two thermocouples, for example, can be provided. The thermocouples can be integrated in the induction coil as a contact thermometer. The corresponding values can be output and recorded just on an informative basis, for example.

The apparatus 1 also comprises a clamping device 24 for clamping the workpiece or for clamping the integral rotor. The clamping device 24 can be positionable, for example, into three axes of displacement, optionally plus an axis of rotation, in a controlled manner, in particular CNC-controlled. The component or the integral rotor 10 can be clamped horizontally, similarly to the engine structure, on the clamping device 24. The clamping device 24 can be clamped on the rotary table on the machine side with sliding blocks and fixed with a centering system. This guarantees flexibility of the clamping system 24 for other devices as well. It is good to ensure that automatic rotation or indexing of the component or BLISK or integral rotor 10 is possible in the program run. The positioning or displacement unit is preferably designed for operation under vacuum. The apparatus 1 as well as the component 10 can optionally be equipped using an aisle crane. A rotary table can automatically be tilted into the horizontal position for simplified set-up and clamping.

The information as to which BLISK type, which workpiece, which blade and which repair process are to be worked can be delivered to the CNC control, for example by an EDP route card, which controls and monitors the actual heat-treatment operation with predefined programs (e.g., heating times, retention time, cooling time, control limits, etc.). The input values can be supplied according to a defined syntax in ASCII format as a file, e.g., by a diskette or network. The work which is carried out can be documented by the plant in conjunction with the delivered inputs of the EDP route card, difference in shape and position, signals and monitoring devices. An integrated module for PC-assisted parameter documentation can enable the relevant process parameters, such as, for example, heating energy or generator output, times, position, etc., to be stored, namely in particular for each process cycle. It is optionally also possible to indicate pyrometer and thermal imaging camera signals.

The apparatus also comprises a generator 26 which here is provided outside of the working space 12 and serves to activate the induction coil 18. The generator 26 can be integrated into the furnace control or CNC control.

It is also possible for the plant to be controlled manually. A graded operator or access concept for workers, foremen and work preparation can be provided for safety reasons. The apparatus 1 is in particular functional in a normal, non-air-conditioned environment of preferably 10 to 40° C.

An integrated re-cooling device can serve as the cooling system. This can then cool the generator 26 with the coil, as well as the switch cabinet via a closed, temperature-regulated secondary circuit.

The apparatus, including all peripheral instruments, can be isolated from the main power supply by operating a main switch. The main switch can be formed so that it is not switched via switch rods in the door area. This can also be provided with an apparatus which allows it to be closed in the off position (e.g., by a padlock).

In the above description the device which is used for the heat treatment is a HF source by which the component can be inductively heated. However a different device for the heat treatment can also be provided. An electric arc, a laser or an electron beam can alternatively be used under the same conditions.

A vacuum plant is marked with the reference number 28. A matching transformer is marked with the reference number 30. Cooling water can be supplied via the inlet 32 and removed via the outlet 34.

### LIST OF REFERENCE NUMERALS

1 exemplary apparatus according to the invention
10 integral rotor
12 closed or closable working space
14 argon cylinder manifold
16 control device
18 heat source, inductor
20 pyrometer
20a pyrometer
20b pyrometer
20c pyrometer
22 distance-measuring instrument
24 clamping device
26 generator
28 vacuum plant
30 matching transformer
32 inlet for cooling water
34 outlet for cooling water

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for the heat treatment of an integral rotor of a gas turbine, comprising:
a closable working space which is evacuatable or fillable with inert gas;
a heat source disposed within the working space;
a distance-measuring instrument disposed within the working space which measures a distance between the heat source and the integral rotor; and
a pyrometer disposed within the working space which measures a temperature at a location on the integral rotor which receives the heat treatment.

2. The apparatus according to claim 1, wherein the heat source is an inductor, or an induction coil, or a high-frequency source, or an electric arc, or a laser, or an electron beam.

3. The apparatus according to claim 1, wherein the heat source produces a local temperature field.

4. The apparatus according to claim 2, wherein the heat source is an inductor or an induction coil and produces a local induction field.

5. The apparatus according to claim 4, wherein the local induction field, which, for local heat treatment or for local heating, is at an annealing temperature of the integral rotor and wherein the integral rotor consists of titanium or of a nickel-based material or of a cobalt-based material.

6. The apparatus according to claim 1, further comprising a monitoring device for monitoring a partial pressure of a vacuum and/or of the inert gas in the working space.

7. The apparatus according to claim 1, wherein the heat source is pivotable.

8. A method for diminishing and/or for eliminating internal stresses introduced into a component through welding, comprising the steps of:
placing the component in a closable working space;
evacuating the closable working space and/or flooding the closable working space with an inert gas; and
locally heat-treating the component or a component portion by a heat source.

9. The method according to claim 8, wherein the method is carried out by an apparatus according to claim 1.

10. The method according to claim 8, further comprising the step of monitoring and/or regulating a distance between the heat source and the component or a location on the component that is heat-treated.

11. The method according to claim 8, further comprising the step of controlling and/or regulating the heat source by values which are detected by a pyrometer.

12. The method according to claim 8, wherein the component is an aircraft component.

13. The method according to claim 12, wherein the aircraft component is a blade.

14. The method according to claim 8, wherein the inert gas is argon.

15. The method according to claim 8, wherein the heat source is an inductor, or an induction coil, or a high-frequency source, or an electric arc, or a laser, or an electron beam.
